(19) United States
(12) Patent Application Publication
(10) Pub. No.: US 2016/0379066 A1
(43) Pub. Date: Dec. 29, 2016

(54) Method and Camera System for Distance Determination of Objects from a Vehicle

(71) Applicant: Robert Bosch GmbH, Stuttgart (DE)

(72) Inventors: Martin Reiche, Weil Der Stadt (DE); Julia Heroldt, Stuttart (DE)

(21) Appl. No.: 15/190,232

(22) Filed: Jun. 23, 2016

(30) Foreign Application Priority Data
Jun. 23, 2015 (DE) 10 2015 211 574.7
Apr. 18, 2016 (DE) 10 2016 206 493.2

(51) Int. Cl. G06K 9/00; G06T 7/00; H04N 5/247

(52) U.S. Cl. CPC G06K 9/00805; H04N 5/247; G06T 7/004; G06T 2207/10004

(57) ABSTRACT

Proposed is a camera system and a method for distance determination of objects from a vehicle using two cameras, which capture different and yet at least partially overlapping fields of view, wherein the cameras have differently configured optics and the images of the cameras are used to carry out a distance determination of an object in the overlap region of the cameras.

This application claims priority under 35 U.S.C. §119 to application no. DE 10 2015 211 574.7, filed on Jun. 23, 2015 in Germany and to application no. DE 10 2016 206 493.2, filed on Apr. 18, 2016 in Germany, the disclosures of which are incorporated herein by reference in their entirety.

### BACKGROUND

The present disclosure relates to a method or a camera system for determining distances of objects from a vehicle using at least two cameras.

The publication Führer, D. I. T., Heger, I. T., & Heckel, M. S. J. (2014), Stereo-Videokamera als Basis für Assistenzfunktionen, ATZ-Automobiltechnische Zeitschrift, 116 (2), 22-27 has already disclosed stereo camera systems which ascertain, on the basis of two identically configured optical paths, the distance from an object in their overlap region and incorporate this information in driver assistance systems. The stereo video camera generates what is known as stereoscopic disparity information, i.e. it establishes a precise 3D map of the vehicle environment from the comparison between the left and right images. The resulting depth map comprises a highly accurate distance calculation for all points within the overlap region of the camera images.

Laid-open specification DE112012003685T5 furthermore introduces a system which comprises an image processing apparatus that consists of a first and second image recording unit having wide-angle lenses which can record at least partially overlapping images. The system furthermore consists of a distance measurement unit which calculates the distance of the local vehicle from an object on the basis of a large number of images which were recorded by the first and second image recording units. The calculation of the distance can be carried out, among others, on the basis of the incidence angles determined by an incidence angle determination unit.

With ideally parallel optical axes of the cameras used, identical focal lengths f and the known base distance b between the cameras, it is possible to determine, from the disparity D of a feature on the images captured by the cameras or image sensors, the distance g to the object that is associated with the feature:

g=f*b/D

This law is simply omitted at this point since the optical paths of both cameras are approximately identical.

JP H11-39596 A discloses a camera system, consisting of two stereo video cameras. The stereo video cameras here have different image angles. Distance determination of objects is possible on the basis of the captured images of in each case one stereo video camera, while the images of the respectively other stereo video camera are not used in the distance determination. For objects located in an overlap region of the fields of view of the two stereo video cameras, the distances ascertained by the respectively individual stereo video cameras are compared to one another.

### SUMMARY

The present disclosure relates to a camera system for the distance measurement of objects from a vehicle using at least two cameras, which capture different and yet at least partially overlapping image regions. The core of the disclosure can be found in that the layouts of the images of at least two cameras differ and in that the images, captured by at least two cameras, of an object in the overlap region of the fields of view of the cameras are used in an evaluation unit for determining the distance of the object from the vehicle.

The disclosure makes possible a distance determination of objects using at least two cameras having differently configured optics. As opposed to a stereo video camera, the cameras used do not have to have the same construction and meet identical imaging laws. It is thus possible to construct a system which can cover different image regions with differently designed cameras, for example with a wide-angle lens and a telephoto lens, and at the same time can carry out distance determination of the objects located in the overlap region. The disclosed camera system makes possible this covering of the image regions using just two mono cameras. This results in a significant cost reduction compared to already known camera systems which use two stereo video cameras to cover the same image region.

The suggested disclosure could be used particularly for driver assistance or safety functions. Systems, such as for example emergency braking systems, lane keeping assist, lane change assist, traffic sign recognition, systems for distance control, comfort systems such as traffic jam assist, construction zone assist, and comparable systems are conceivable.

The advantage of the disclosure becomes particularly clear at this point since with one camera system, several assistance functions are conceivable. In the different systems, it is in some cases necessary to image several lanes in close proximity of the vehicle, which is preferably realizable using cameras with a very wide field of view, in particular with wide-angle lenses. Other systems, such as traffic sign recognition or an assistance function, which must detect objects and/or vehicles that are far away, require for this preferably a camera system which uses for example a telephoto lens, with which objects that are far away can be imaged sharply.

The suggested disclosure thus makes possible, using a camera system, to meet the requirements of different driver assistance functions and/or functions for autonomous driving, for which at least two conventional/known camera systems would be necessary. As a result, costs can be reduced or alternatively a greater number of assistance or safety functions can be realized with just one camera system.

What is understood by layout of the images can be, for example, the fields of view and/or the image angles and/or the light sensitivity and/or the separability and/or the pixel resolution and/or the color filter pattern of the image of the cameras used.

In the disclosed camera system, the fields of view and/or the image angles of the cameras can differ in any desired fashion. The fields of view designate the image regions captured by the cameras and are frequently also referred to as FOV, the limits of which are given by the image angles of the cameras.

The arrangements of the cameras can differ from one another in any desired fashion, for example in that their positions with respect to one another vary and/or the alignments, more specifically the directions and alignments of the optical axes, differ with respect to one another. The cameras can here have parallel and/or diverging and/or converging optical axes.

The at least two cameras can furthermore be arranged in a housing, in which optionally also an evaluation unit can be mounted, which, however, can also be arranged at any other location in the vehicle. The cameras can additionally be housed in at least two completely separate housings, which are located at different locations in the vehicle. The evaluation unit can in this case also be located at any desired position in the vehicle, or alternatively be housed in one of the camera housings.

The objective lenses of the cameras used, the optical images of which can be described for example by parameters such as field of view, image angle, focal lengths and/or distances of the image sensors, can differ in any desired fashion from one another, such that for example at least one wide-angle lens is used and the optics of at least a further camera for example has a telephoto lens.

According to the disclosure, a method for distance determination of objects from a vehicle is additionally introduced, having at least two cameras, which capture different and yet at least partially overlapping image regions, characterized in that the layouts of the images of at least two cameras differ from one another and in that the images of an object captured by at least two cameras in the overlap region are used in an evaluation unit for determining the distance of the object from the vehicle.

The cameras used for the application of the method according to the disclosure can be characterized in that the layouts of the images differ in that the cameras have different fields of view and/or image angles and/or in that the imaging scale and/or distortions of the images differ from one another.

In order to determine the distance of the object from the vehicle, it is possible in a further step to take into account at least one of the fields of view and/or at least one of the image angles. To calculate the distance, it is furthermore possible for the captured images of the cameras to be used and/or it is possible for the consideration of the alignment of the cameras with respect to one another to be used, in particular the alignment of the optical axes. Also included in the calculation can be furthermore the positioning of the cameras with respect to one another, in particular the base distance of the cameras, the consideration of the correction of the images captured by the cameras by way of back-calculating the distortion and/or the consideration of the ascertained corrected positions of an object in the image of at least two cameras by which the object was captured.

In the determination of the distance of the object from the vehicle, additionally the ascertained angle difference of the object angles of at least two cameras can be used. The object angle of a camera here describes the angle between the optical axis of the camera and the imaginary line from the camera to the detected object. The camera can therefore be used as a reference point, since the distance between camera and image sensor is very small compared to the distance between camera and detected object. Alternatively, the reference point can also be defined differently, for example the center point of the frontmost lens, with respect to the object, or the front or rear focal point or the image sensor or the camera housing can be used, for example All said points are located in each case on the optical axis of the corresponding camera. If the reference point is clearly defined, a recalculation of the object angle to any desired other reference point can be carried out at any time. By using a more accurately specified reference point, alternative descriptions of the object angle result, such as:
The object angle describes here the angle between the optical axis and an imaginary line from the intersection of the frontmost lens, with respect to the object, and the optical axis of the camera to the object.
The object angle here describes the angle between the optical axis and an imaginary line from the intersection of the frontmost focal point, with respect to the object, and the optical axis of the camera to the object.
As described, it is irrelevant if the intersection taken is that of the optical axis with the vertex of the first lens or, for example, the entrance pupil, since the object distances are very large compared to this increment of entrance pupil to the lens vertex.

### BRIEF DESCRIPTION OF THE DRAWINGS

Exemplary embodiments of the disclosure are presented in the drawings an are explained in more detail in the description below.

In the drawings:

FIG. 1 shows an exemplary camera system, consisting of two cameras having different fields of view and image angles.

FIG. 2 shows a diagram for illustrating the method used.

FIG. 3 shows an exemplary profile of the image height over the object angle of two cameras.

FIG. 4 shows exemplary optical imaging for the definition of a few terms.

FIG. 5 shows the distortions of the two cameras plotted over the image height.

FIG. 6 shows the distortions of the two cameras plotted over the object angle.

### DETAILED DESCRIPTION

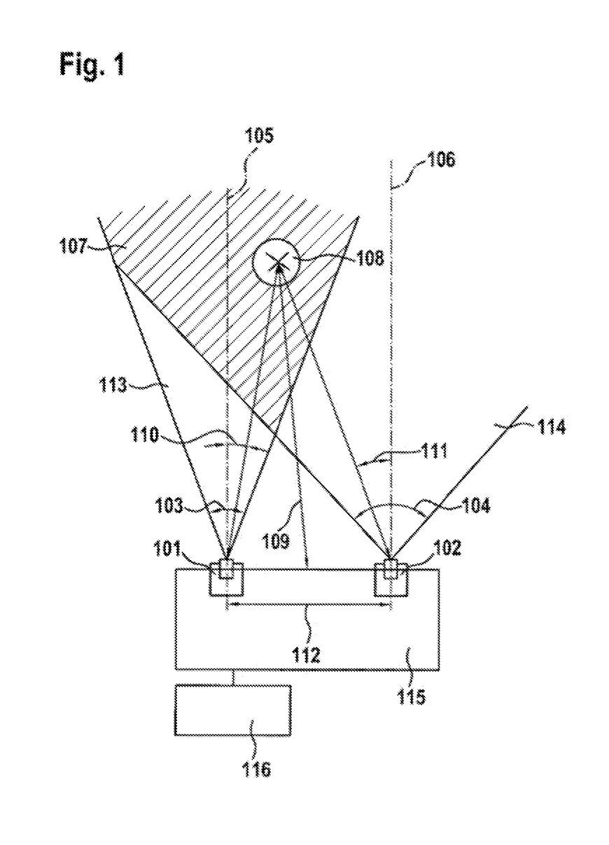

FIG. 1 shows by way of example the construction of a camera system consisting of two cameras 101, 102, which are arranged at a specific distance 112 with respect to one another. In the example given, the optical axes 105, 106 of the cameras 101, 102 are parallel with respect to one another, but alternatively can also be arranged such that they converge or diverge.

The cameras 101, 102 are housed in a common housing 115, which is possible as an option, but does not represent a requirement. In addition, the camera system is connected to an evaluation unit 116, which can optionally be mounted in the same housing 115 or can be located outside at any other position.

The two cameras 101, 102 have different fields of view 113, 114 or different image angles 103, 104. The fields of view 113, 114 overlap in a region 107, which is thus captured by both cameras. An object 108 is located in the overlap region 107. The object 108 is perceived by both cameras 101, 102 under a specific object angle 110, 111. The determination of the distance 109 of the object 108 from the vehicle is carried out using the method according to the disclosure.

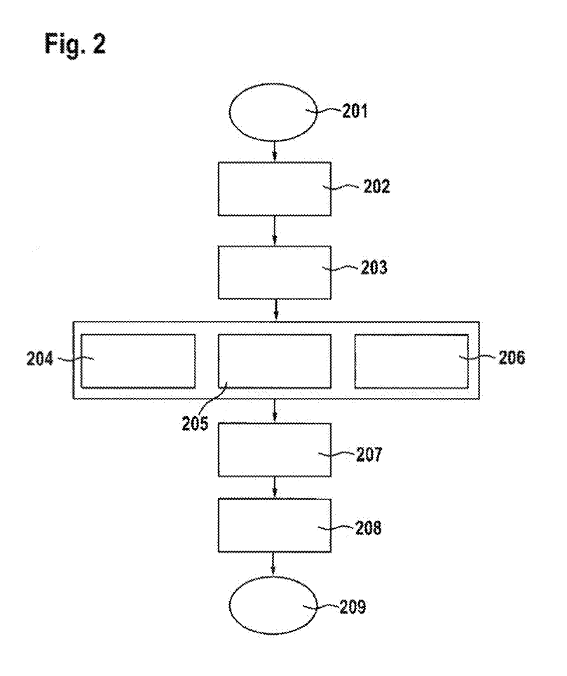

FIG. 2 schematically illustrates the disclosed method for distance determination on the basis of a flowchart. In the beginning of the method 201, the technical data of the cameras 101, 102 is known, including, for example, the position of the cameras 101, 102, the distance 112 between them, the alignment of the optical axes 105, 106, the image angles 103, 104 and the fields of view 113, 114.

This information has been and/or is noted 202 in a system before the image data is read 203. The sequence of processing at this point, however, is irrelevant, and step 202 can thus be used at any desired point between 201 and 207.

After the data has been read 203, the distortion correction of the images takes place in step 204, that is to say back-calculation of the distortion of the cameras 101, 102, see explanation using the following figures. The images can then be normalized in step 205 to a common system, such that the determination of the object angles 110, 111 of a common object 108 in the region 107 that is captured by both cameras 101, 102 can be carried out in step 206. The steps 204, 205, 206 can be interchanged as desired, while the result of the method does not change.

In the subsequent step 207, the distance 109 is calculated taking into consideration the already known technical data of the cameras 101, 102 and the determined object angles 110, 111. Instead of the object angles 110, 111, it is also possible to use for the calculation the positions of the object 108 on the corrected images that are captured by the cameras 101, 102. It is possible to ascertain the disparity using these positions, just as it is possible using the object angles 110, 111. That means that the determination of the distance 109 can also take place with consideration of the ascertained distance of the images of the object 109 captured by the cameras 101, 102.

The method gives as the result 208 the distance of the object 109 from the vehicle. The exact reference point from which the distance 109 is measured can be defined based on the requirements of the camera system. After the distance is output and/or transmitted 208, the distance determination terminates and can be carried out once more with the same or any other object. These distance determinations do not run sequentially, but the total images of both cameras measured at the same time are searched in their overlap region for corresponding image contents. After back-calculation of the images to a common imaging law and/or a common scale, it is possible to determine from the disparity a depth map over the object space.

Ascertainment of the distance 109 is not limited to one object 108; it is possible to determine at the same time the distances of all objects in the overlap region and to thus establish a precise 3D map of the vehicle environment captured by the cameras 101, 102. To this end, the steps 201 to 209 can be repeated as often as desired. Ascertainment of the distance 109 from any desired object 108 in the overlap region can be repeated in terms of time, as a result of which the temporal change of the distance from the object 108 can be determined This can in turn be carried out with a desired number of objects in the overlap region, as long as the objects are captured by both cameras. As a result, a speed measurement of the vehicle is possible, for example.

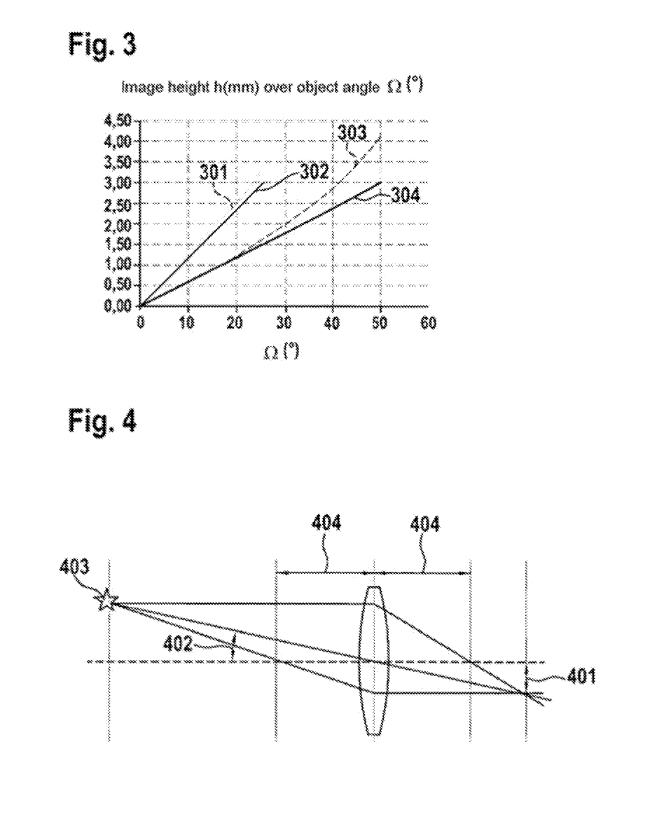

In FIG. 3, the image height h 401 of two cameras 101, 102 is plotted over the object angle 110, 111, by way of example. The image height 401 is illustrated by way of example in FIG. 4 on the basis of an image of the lens optics. Likewise plotted in FIG. 4 are once again the object angle 402 to the object 403 and the focal lengths of the lens 404.

In the following exemplary embodiment of the camera system, the optical axes of both cameras 101, 102 are ideally collinear, and the base distance 112 between the two cameras 101, 102 is given. In a first approximation, the images of the cameras 101, 102 with respect to their optical axes 105, 106 are rotationally symmetrical, describable as the image height hΩ 401 over the object angle Ω 402. In the example, a maximum image height of the image sensor of 3 mm is assumed, which corresponds to approximately half the diagonal of the optically active rectangle of the image sensor.

The imaging laws of the two cameras 101, 102 are assumed in this example to be approximately linear, with the slope of the focal length f 404. Camera 1 101 here has a maximum object angle 110 of 25°, camera 2 102 has a maximum object angle of 50°. The different image heights plotted over the angle 302, 304 of the two cameras 101, 102 are illustrated in FIG. 3. The image height 302 here corresponds to the image height of the camera 1 101 and correspondingly the image height 304 to the camera 2 102. In addition, the corresponding image heights of an ideal image according to a pinhole camera h_s=f*tanΩ are illustrated in dashed lines 301, 303, wherein h_s represents the image height of the pinhole camera image, f the focal length and Ω the object angle 402. These ideal imaging curves 301, 303 form the reference for the so-called distortion.

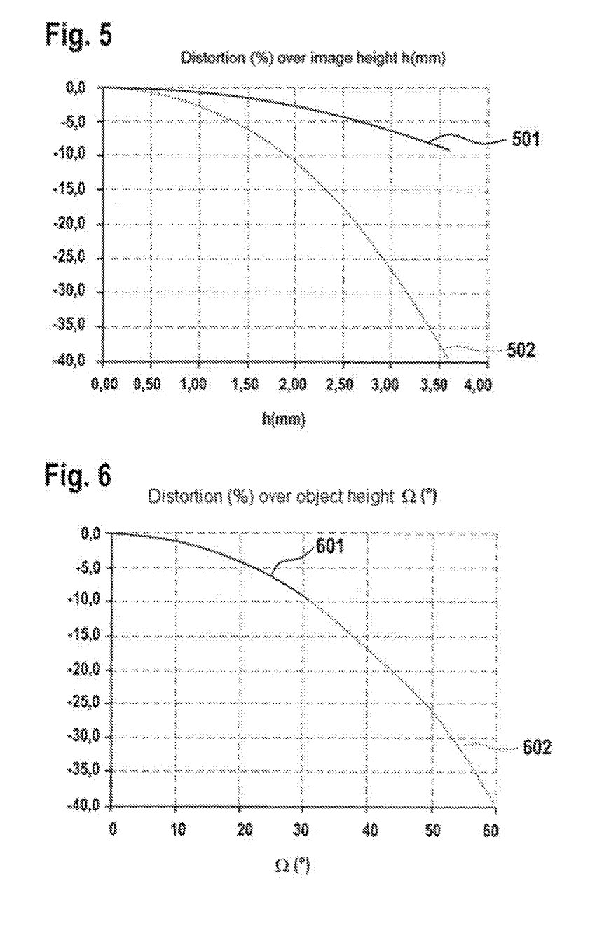

In FIG. 5, the distortions 501, 502 of both cameras 101, 102 are plotted over the image height 401, as a result of which two completely different curve profiles result. The distortion 501 here corresponds to the distortion of the camera 1 101 and the distortion 502 corresponds to the distortion of the camera 2 102. If both distortions 601, 602 are plotted over the object angle 402, the same distortions are obtained for the two optical paths of the cameras 101, 102. The distortion 601 here corresponds to the distortion of the camera 1 101 and the distortion 602 corresponds to the distortion of the camera 2 102.

Based on these relationships, it is possible to describe a procedure with which the distance 109 of an object 108 in the overlap region 107 of the fields of view 113, 114 of the two cameras 101, 102 can be determined:
In accordance with the pixel grids of the camera 1 101 and camera 2 102, the captured images are distortion corrected, which means that the distortion is back-calculated.
After the distortion correction, the corrected positions of the object 108 in the images of the cameras 101, 102 are ascertained, that is to say in the captured images of the cameras 101, 102.
Then follows the ascertainment of the difference of the object angles 110, 111 of the cameras 101, 102.
Subsequently, the object distance is determined from the angle difference and the base distance 112.

What is claimed is:

1. A method for distance determination of an object from a vehicle, the method comprising:
capturing two images of the object using two cameras configured such that the two images have (i) different and yet at least partially overlapping fields of view of the object and (ii) different image angles; and
determining, with an evaluation unit, a distance of the object from the vehicle based on the two images of the object captured by the the two cameras.

2. The method according to claim 1, the capturing of the two images further comprising:
capturing the two images with the two cameras configured such that the two images have at least one of (i) different imaging scales and (ii) different distortions.

3. The method according to claim 1, the determining of the distance further comprising:
taking into consideration at least one of the image angles.

4. The method according to claim 1, wherein the two cameras are mono cameras.

5. The method according to claim 1, the determining of the distance further comprising:
comparing the two images of the object captured by the two cameras.

6. The method according to claim 1, the determining of the distance further comprising:
taking into consideration an alignment of optical axes of the two cameras, with respect to one another.

7. The method according to claim 1, the determining of the distance further comprising:
taking into consideration a positioning of the two cameras with respect to one another, wherein provision is made for taking into consideration a base distance of the cameras.

8. The method according to claim 1, the determining of the distance further comprising:
correcting the two images captured by back-calculation of a distortion.

9. The method according to claim 1, the determining of the distance further comprising:
ascertaining corrected positions of the object.

10. The method according to claim 1, the determining of the distance further comprising:
ascertaining an angle differences between optical axes of the two cameras and imaginary lines from the two cameras to the object.

11. A camera system for distance determination of an object from a vehicle, the system comprising:
two cameras configured to capture two images of the object such that the two images have (i) different and yet at least partially overlapping fields of view of the object and (ii) different image angles; and
an evaluation unit configured to determine a distance of the object from the vehicle based on the two images of the object captured by the the two cameras.

12. The camera system according to claim 11, wherein the two cameras are mono cameras.

13. The camera system according to claim 11, wherein the two cameras are configured to capture the two images with different distortions.

14. The camera system according to claim 11, wherein the two cameras are housed in a common housing.

15. The camera system according to claim 11, wherein the two cameras have at least one of parallel, converging, and diverging optical axes.
